(19) United States
(12) Patent Application Publication
(10) Pub. No.: US 2017/0139126 A1
(43) Pub. Date: May 18, 2017

(54) BACKLIGHT MODULE AND LIQUID CRYSTAL DISPLAY DEVICE

(71) Applicant: Wuhan China Star Optoelectronics Technology Co., Ltd., Wuhan (CN)

(72) Inventors: Shih-Hsiang Chen, Shenzhen (CN); Pengbo Xu, Shenzhen (CN)

(73) Assignee: Wuhan China Star Optoelectronics Technology Co., Ltd., Wuhan (CN)

(21) Appl. No.: 14/994,468

(22) Filed: Jan. 13, 2016

(30) Foreign Application Priority Data
Nov. 18, 2015 (CN) 201510796505.8

(51) Int. Cl. F21V 8/00

(52) U.S. Cl. CPC G02B 6/0091; G02B 6/0055; G02B 6/0073; G02B 6/0068

(57) ABSTRACT

The Present invention provides a backlight module, comprising a glue frame, a light guide plate and a light source assembly accommodated in the glue frame, and the light guide plate comprises an illuminating surface and an incident surface connected to the illuminating surface, and the light source assembly comprises a flexible circuit board, a plurality of first lamp sources and a plurality of second lamp sources, and the glue frame and the light guide plate support the flexible circuit board, and the plurality of first lamp sources and the plurality of second lamp sources are located between the incident surface of the light guide plate and the glue frame; the plurality of first lamp sources and the plurality of second lamp sources are located on the flexible circuit board, and are staggered and aligned in a straight line with equal spaces.

### FIELD OF THE INVENTION

The present invention relates to a liquid crystal display field, and more particularly to a backlight module and a liquid crystal display device.

### BACKGROUND OF THE INVENTION

At present, a liquid crystal display device as being the display component of the electronic device has been widely applied in various kinds of electronic products. With the lightening development of the electronic products, the thickness of the liquid crystal display device becomes smaller and smaller, too. The backlight module is an important component in the liquid crystal display device.

In prior art, the liquid crystal display product is developed to be thinner and larger, and to have high brightness and high color gamut. The brightness and the color gamut of the light source of the backlight module is required to be higher and higher. The light source is the factor of determining the image high brightness and high color gamut of the display device. In the backlight module of prior art, the general 3004LED is commonly utilized for the backlight lamp source. For the display device of 4.7 inch, twelve 3004LEDs are utilized for satisfying the narrow frame and thin type shape condition. The brightness of the 3004LED is lower and the brightness becomes insufficient; moreover, the light spots (firefly phenomenon) can easily appears when the light mixing distance is not set appropriately. If all utilizes the LEDs of which the brightness is higher to be the backlight source, the volume of the LEDs increases, and the volume of the backlight module will increase, too.

### SUMMARY OF THE INVENTION

The embodiment of the present invention provides a backlight module and a liquid crystal display device, ensuring to satisfy the brightness of the liquid crystal display device without increasing the volume of the backlight module at the same time.

The present invention provides a backlight module, comprising a glue frame, a light guide plate and a light source assembly accommodated in the glue frame, and the light guide plate comprises an illuminating surface and an incident surface connected to the illuminating surface, and the light source assembly comprises a flexible circuit board, a plurality of first lamp sources and a plurality of second lamp sources, and the glue frame and the light guide plate support the flexible circuit board, and the plurality of first lamp sources and the plurality of second lamp sources are located between the incident surface of the light guide plate and the glue frame; the plurality of first lamp sources and the plurality of second lamp sources are located on the flexible circuit board, and the plurality of first lamp sources and the plurality of second lamp sources are staggered and aligned in a straight line with equal spaces, and each first lamp source forms a gap with the adjacent second lamp source, and a lamp body length of the first lamp source is larger than a lamp body length of the second lamp source, and a brightness of the first lamp source is larger than a brightness of the second lamp source.

An amount of the first lamp sources is equal to an amount of the second lamp sources, the amount of the first lamp sources is one more than the amount of the second lamp sources, or the amount of the first lamp sources is one less than the amount of the second lamp sources.

A model of the first lamp source is 3804LED lamp, and a model of the second lamp source is 3004LED lamp.

The glue frame comprises a side wall, and the side wall comprises a top surface and a lateral surface connected to the top surface, and the lateral surface faces the incident surface, and the lateral surface is provided with a partition corresponding to the gap, and two sides of the flexible circuit board respectively abut against the top surface and the light guide plate, and the partition is accommodated in the gap between the first lamp source and the second lamp source, and supports the flexible circuit board.

The backlight module further comprises a reflective sheet, and the reflective sheet is fixed on one side of the glue frame away from the illuminating surface of the light guide plate, and the reflective sheet stacks up with the light guide plate.

Thicknesses of the first lamp source and the second lamp source are the same.

The first lamp source is a high color gamut LED lamp.

The present invention provides a display device, comprising a liquid crystal panel and the backlight module, and the liquid crystal panel is located on the backlight module and opposite to the illuminating surface.

The first lamp source is a high color gamut LED lamp.

The liquid crystal panel comprises a color filter substrate, an array substrate opposite to the color filter substrate and a glue frame connecting the color filter substrate with the array substrate, and the color filter substrate, the array substrate and the glue frame surround to form an accommodation space for accommodating liquid crystals.

The light source assembly of the backlight module according to the present invention utilizes the first lamp sources and the second lamp sources of which the brightnesses are different to be alternately aligned to realize the complementation for the lights of two kinds of lamp sources for promoting the light source brightness of the backlight module.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a sectional diagram of a backlight module according to the present invention.

FIG. 2 is a plane view diagram of a light source assembly and a glue frame of the backlight module assembled and shown in FIG. 1.

FIG. 3 is a sectional diagram of the backlight module of the present invention from another angle.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

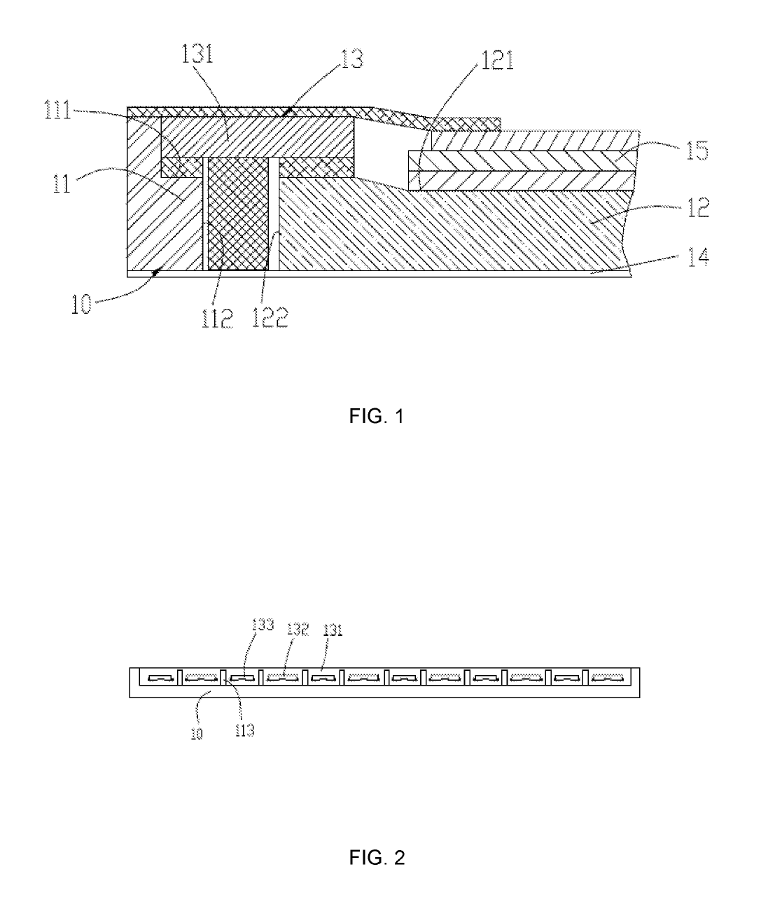

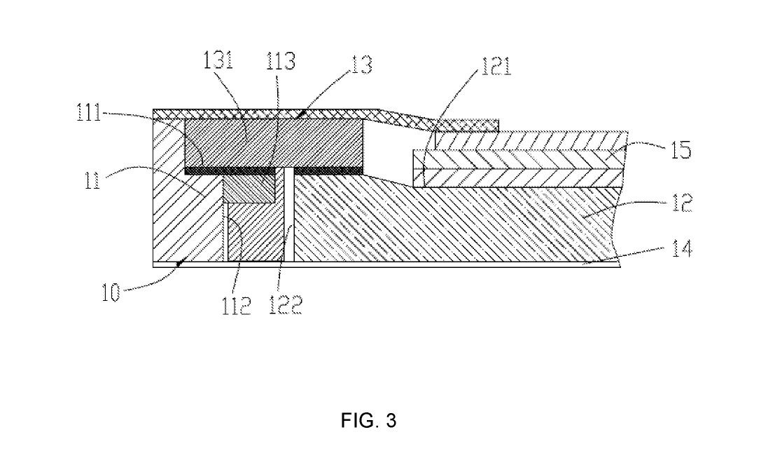

Please refer to FIG. 1, FIG. 2 and FIG. 3. The preferred embodiment of the present invention provides a backlight module, employed to provide the light source for display device. The backlight module comprises a glue frame 10, a light guide plate 12 and a light source assembly 13 accommodated in the glue frame 10. The light guide plate 12 comprises an illuminating surface 121 and an incident surface 122 connected to the illuminating surface 121. The light source assembly 13 comprises a flexible circuit board 131, a plurality of first lamp sources 132 and a plurality of second lamp sources 133. The glue frame 10 and the light guide plate 12 support the flexible circuit board 131, and the plurality of first lamp sources 132 and the plurality of second lamp sources 133 are located between the incident surface 122 of the light guide plate 12 and the glue frame 10; the plurality of first lamp sources 132 and the plurality of second lamp sources 133 are staggered and aligned in a straight line with equal spaces on the flexible circuit board 131, and each first lamp source 132 forms a gap with the adjacent second lamp source 133. A lamp body length of the first lamp source 132 is larger than a lamp body length of the second lamp source 133, and a brightness of the first lamp source 132 is larger than a brightness of the second lamp source 133.

Furthermore, an amount of the first lamp sources 132 is equal to an amount of the second lamp sources 133, the amount of the first lamp sources 132 is one more than the amount of the second lamp sources 133, or the amount of the first lamp sources 132 is one less than the amount of the second lamp sources 133.

In this embodiment, the amount of the first lamp sources 132 is equal to the amount of the second lamp sources 133. Specifically, the amount of the first lamp sources 132 is 6, and the amount of the second lamp sources 133 is 6. The 4.7 inch screen is illustrated for explanation for the backlight module in this embodiment. The flexible circuit board 131 is a strip shape, and the six first lamp sources 132 and the six second lamp sources 133 are staggered and aligned with equal spaces on one surface of the flexible circuit board 131; namely, the six first lamp sources 132 and the six second lamp sources 133 are in a straight line. The length extension direction of the first lamp sources 132, the length extension direction of the second lamp sources 133 and the length extension direction of the flexible circuit board 131 are the same.

In the present invention, the light source assembly utilizes the first lamp sources 132 and the second lamp sources 133 of which the brightnesses are different to be alternately aligned to realize the complementation for the lights of two kinds of lamp sources for promoting the light source brightness of the backlight module. A lamp body length of the first lamp source 132 is larger than a lamp body length of the second lamp source 133. Thus, in the limited length space of the flexible circuit board 131, the space is utilized as possible for the distribution of the lam sources under circumstance that the certain gaps are ensured to reduce the light mixing distance between the two kinds of lamp sources to prevent the speckle phenomenon. Meanwhile, there is no need to increase the volume of the backlight module. Besides, the present invention utilizes two kinds of lam sources rather than all for LEDs with higher brightness. Because the volume of the LED with higher brightness is larger, the volume of the backlight module will be increased. Meanwhile, part of light sources will not be necessary and wasted because the light saturation of the display device.

In this embodiment, preferably, a model of the first lamp source is 3804LED lamp, and a model of the second lamp source is 3004LED lamp. The model of the first lamp source is 3804LED lamp. The brightness thereof is larger than that of the model of the second lamp source which is 3004LED lamp. The first lamp sources 132 and the second lamp sources 133 are mixed for usage. The 3804LED lamp can compensate the insufficient brightness issue of the 3004LED lamp, and the lamp length of the 3804LED lamp is larger than the lamp length of the 3004LED lamp. The dimension of the flexible circuit board 131 can be fully and reasonably utilized to ensure that sufficient lam sources are in the limited space.

In this embodiment, the glue frame is a rectangular frame, comprising a side wall 11. The side wall 11 comprises a top surface 111 and a lateral surface 112 connected to the top surface 111, and the lateral surface 112 faces the incident surface 122. The lateral surface 112 is provided with a partition 113 corresponding to the gap, and two sides of the flexible circuit board 131 respectively abut against the top surface 111 and the light guide plate 12, and the partition 113 is accommodated in the gap between the first lamp source 132 and the second lamp source 133, and supports the flexible circuit board 131. The partition 113 is employed to support the flexible circuit board 131 to preventing the flexible circuit board 131 from being bent cause it loads too many lamp sources. Specifically, the two sides of the flexible circuit board 131 respectively abut against the top surface 111 and the illuminating surface 121 of the light guide plate 12 which is close to the incident surface 122, and the first lamp sources 132 and the second lamp sources 133 are located between the incident surface 122 of the light guide plate 12 and the glue frame 10, and Both the lights of the first lamp sources 132 and the second lamp sources 133 enter the light guide plate 12 from the incident surface 122 and illuminate from the illuminating surface 121 after being uniformed by the light guide plate.

Moreover, the backlight module further comprises a reflective sheet 14, and the reflective sheet 14 is fixed on one side of the glue frame 10 away from the illuminating surface 121 of the light guide plate 12, and the reflective sheet 14 stacks up with the light guide plate 12. In this embodiment, the reflective sheet 14 can be the backlight module base plate for loading the glue frame, the light guide plat and the light source assembly. An optical thin film layer 15 further stacks up on the illuminating surface of the light guide plate 12. The edges of the optical thin film layer is adhered and fixed to the glue frame with colloid.

Furthermore, specifically, the thicknesses of the first lamp source 132 and the second lamp source 133 are the same. Compared with the prior art utilizing single LED lam source, the present invention utilizes mixed lam sources to increase brightness of the backlight module without increasing the thickness of the glue frame. Namely, it ensures that the entire thickness of the backlight module does not change.

Furthermore, the first lamp source 132 is a high color gamut LED lamp for promoting the display color gamut.

The present invention provides a display device, comprising a liquid crystal panel and the backlight module, and the liquid crystal panel is located on the backlight module and opposite to the illuminating surface. The liquid crystal panel comprises a color filter substrate, an array substrate opposite to the color filter substrate and a glue frame connecting the color filter substrate with the array substrate, and the color filter substrate, the array substrate and the glue frame surround to form an accommodation space for accommodating liquid crystals. The color filter substrate is one side of the display device showing images.

When the first lam source is the high color gamut LED lamp, the display color gamut can be promoted to enhance the image colors. Although the promotion of the color gamut will affect the brightness of the LED, the brightness of the first lamp source is larger than the brightness of the second lamp source, and two kinds of the lam sources are utilized at the same time, thus the brightness will be sufficient. Meanwhile, the color film layer thickness of the color filter substrate can be decreased to promote the penetration ability of the light source of the backlight module for similarly raising the display brightness.

Above are embodiments of the present invention, which does not limit the scope of the present invention. Any modifications, equivalent replacements or improvements within the spirit and principles of the embodiment described above should be covered by the protected scope of the invention.

What is claimed is:

1. A backlight module, comprising a glue frame, a light guide plate and a light source assembly accommodated in the glue frame, and the light guide plate comprises an illuminating surface and an incident surface connected to the illuminating surface, and the light source assembly comprises a flexible circuit board, a plurality of first lamp sources and a plurality of second lamp sources, and the glue frame and the light guide plate support the flexible circuit board, and the plurality of first lamp sources and the plurality of second lamp sources are located between the incident surface of the light guide plate and the glue frame; the plurality of first lamp sources and the plurality of second lamp sources are located on the flexible circuit board, and the plurality of first lamp sources and the plurality of second lamp sources are staggered and aligned in a straight line with equal spaces, and each first lamp source forms a gap with the adjacent second lamp source, and a lamp body length of the first lamp source is larger than a lamp body length of the second lamp source, and a brightness of the first lamp source is larger than a brightness of the second lamp source.

2. The backlight module according to claim 1, wherein an amount of the first lamp sources is equal to an amount of the second lamp sources, the amount of the first lamp sources is one more than the amount of the second lamp sources, or the amount of the first lamp sources is one less than the amount of the second lamp sources.

3. The backlight module according to claim 1, wherein a model of the first lamp source is 3804LED lamp, and a model of the second lamp source is 3004LED lamp.

4. The backlight module according to claim 3, wherein the glue frame comprises a side wall, and the side wall comprises a top surface and a lateral surface connected to the top surface, and the lateral surface faces the incident surface, and the lateral surface is provided with a partition corresponding to the gap, and two sides of the flexible circuit board respectively abut against the top surface and the light guide plate, and the partition is accommodated in the gap between the first lamp source and the second lamp source, and supports the flexible circuit board.

5. The backlight module according to claim 1, wherein the backlight module further comprises a reflective sheet, and the reflective sheet is fixed on one side of the glue frame away from the illuminating surface of the light guide plate, and the reflective sheet stacks up with the light guide plate.

6. The backlight module according to claim 1, wherein thicknesses of the first lamp source and the second lamp source are the same.

7. The backlight module according to claim 1, wherein the first lamp source is a high color gamut LED lamp.

8. A display device, comprising a liquid crystal panel and the backlight module according to claim 1, and the liquid crystal panel is located on the backlight module and opposite to the illuminating surface.

9. The display device according to claim 8, wherein the first lamp source is a high color gamut LED lamp.

10. The display device according to claim 9, wherein the liquid crystal panel comprises a color filter substrate, an array substrate opposite to the color filter substrate and a glue frame connecting the color filter substrate with the array substrate, and the color filter substrate, the array substrate and the glue frame surround to form an accommodation space for accommodating liquid crystals.
